(19) United States
(12) Patent Application Publication
(10) Pub. No.: US 2008/0224446 A1
(43) Pub. Date: Sep. 18, 2008

(54) Goose neck hook-up helper

(76) Inventor: James Briscoe King, Leighton, AL (US)

Correspondence Address: James B. King, 8215 6th Street Road, Leighton, AL, 35646, US

(21) Appl. No.: 11/895,582

(22) Filed: Nov. 5, 2007

Related U.S. Application Data
(60) Provisional application No. 60/906,278, filed on Mar. 12, 2007.

(51) Int. Cl. B60D 1/36

(52) U.S. Cl. 280/477

(57) ABSTRACT

One embodiment of a custom extruded tube, 30 inches in length with a ¾ inch slit the entire length. This single piece making up this device is specifically designed for the application of attaching a goose neck trailer to a truck. The material is rubberized plastic with an integral reflective yellow pigment added in the extrusion process for superior visibility. The material of the tube allows for it to be used over and over without stretching or breaking. The interior diameter measurement is 2.312 inches and the outer diameter measurement is 2.512 inches. It is designed to fit snuggly over a 2 5/16 Gooseneck ball.

### CROSS-REFERENCE TO RELATED APPLICATIONS

This specification is in reference to application Ser. No. 11/895,582 which was filed on Aug. 27, 2007.

### FEDERALLY SPONSORED RESEARCH

Not Applicable

### SEQUENCE LISTING OR PROGRAM

Not Applicable

### BACKGROUND

1. Field of Invention

This invention relates to a tubular, rubberized plastic and highly visible aide, which, attaches over the vehicle's towing ball to assist the driver in quickly aligning a trailer's gooseneck hitch for attachment.

2. Background

Under normal circumstances, attachment of a Gooseneck Trailer maybe difficult for the driver without another person directing the driver from the back of the vehicle. Truck cabs, whether they be extended, or four door, create a distance and a line of sight barrier for the driver to be able to see both the Gooseneck hitch and the ball to which it will be connected. Additionally, a driver's physical limitations may make it difficult to turn the head or body sufficiently to look behind to align the hitch to the ball.

Due to the above driver limitations, a custom extruded tube with a slit the entire length, was invented. This device was specifically invented to assist the driver when attaching a gooseneck trailer hitch to the ball of a truck. The material is durable Rubberized Plastic with reflective pigment molded as an integral part of the manufacturing process. It is bright yellow in color. When released to the public for a trial period, the helper achieved excellent results.

The Gooseneck Hook-up helper is tubular in shape, 30 inches in length with a ¾″ wide split down the entire length. It has an outside diameter of 2.512, inches and an inside diameter of 2.312 inches. It is designed to fit over a 2 5/16's Gooseneck Ball. The split down the tube should face to the rear of the truck. The driver, without having to turn around to look behind him, may simply line up the trailer in the truck's rear view mirror. When the trailer hitch is correctly lined up with, and comes in contact with the Gooseneck Hook-up helper, the helper will pop off the ball. This will correctly align the trailer hitch with the ball in or on the bed of the truck. The driver then engages the emergency brake to preclude the truck from moving when placed into Park.

### SUMMARY

In accordance with one embodiment a Gooseneck Hook-up helper is a 30″ high, tubular, easily seen guide, designed to slip over a 2 5/16 inch Ball and to assist a driver in easily lining up the Gooseneck hitch to the ball to which it will be connected.

### DRAWINGS

FIG. 1: Shows the Hook-up Helper side view: 30 Inches in Length.

FIG. 2: Shows the Hook-up Helper top view with inside measurement of 2.312 inch diameter.

FIG. 3: Shows the Hook-up Helper side and top views with outside diameter of 2.512 inch diameter and height of 30 inches.

FIG. 4: Side view with the relationship of the Ball with the Hook-Up Helper.

FIG. 5: Side view with the ¾ split.

FIG. 6: Side view of Hook-up Helper with its finished color.

FIG. 7: Sample of the directions that are attached to the Gooseneck Hook-up helper.

### DETAILED DESCRIPTION PREFERRED EMBODIMENT

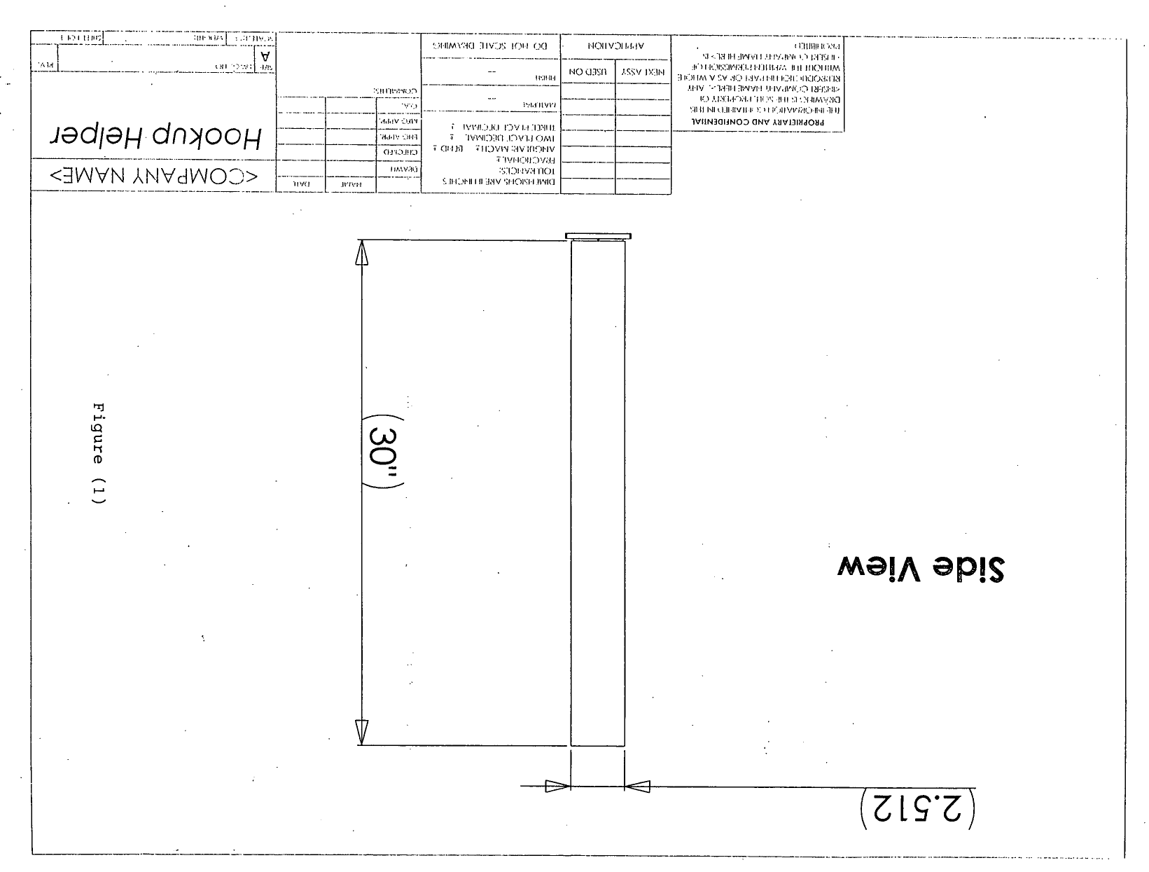

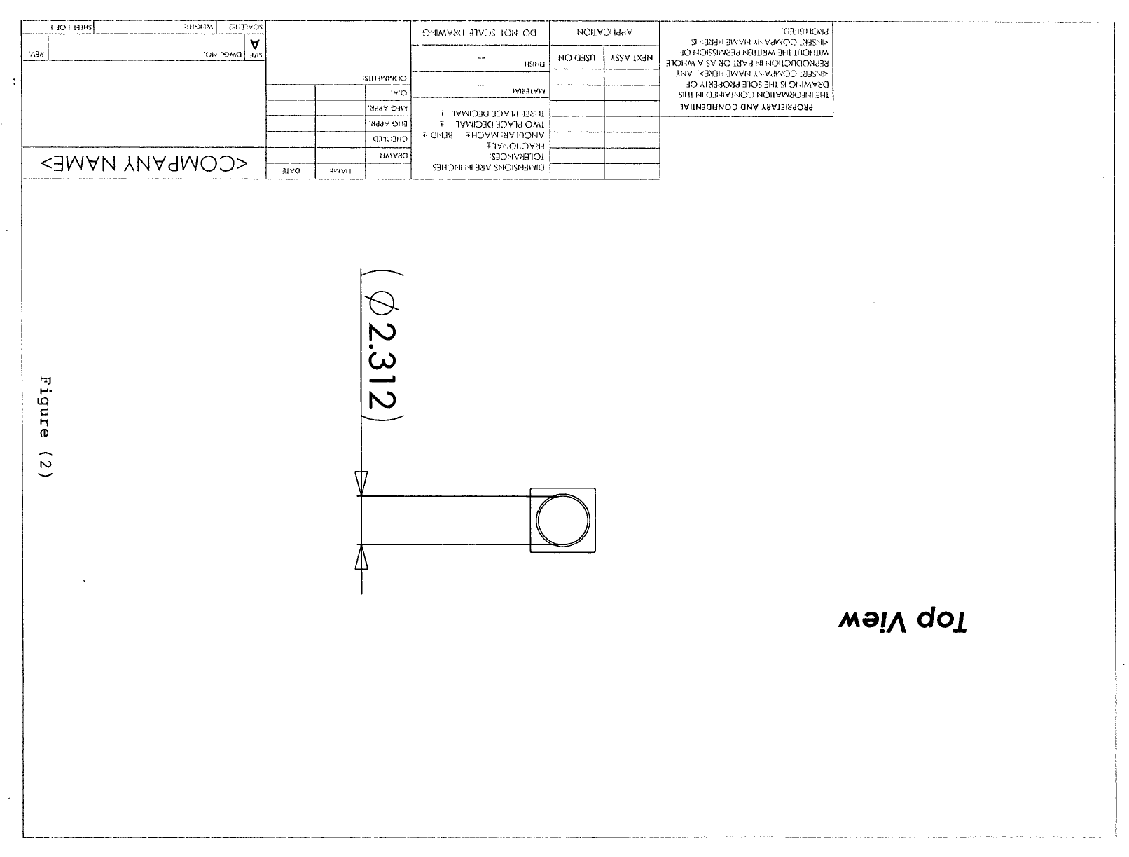

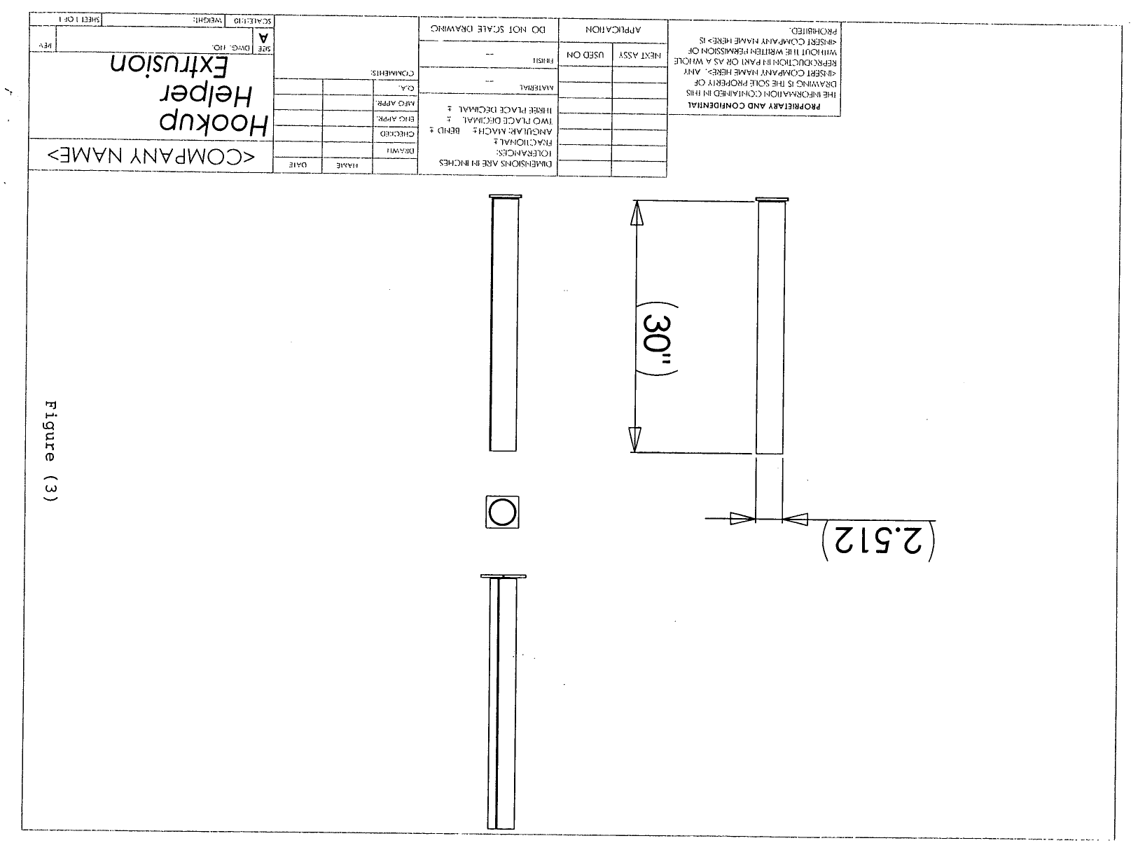

FIG. 1 illustrates the basic tubular shape and length of the “Gooseneck Hook-up Helper”. It has a primary length of 30 inches and is made of an extruded plastic and rubber blend to allow flexibility, thus precluding breakage during use and so that it does not get brittle with age. FIG. 2 illustrates the top view, the “Gooseneck Hook-up Helper” is uniform in internal dimension of 2.312 inches allowing it to fit over a 2 5/16 inch towing ball. The outside dimension FIG. 3, is also uniform at 2.512 inch resulting in an overall thickness of 0.2 inches.

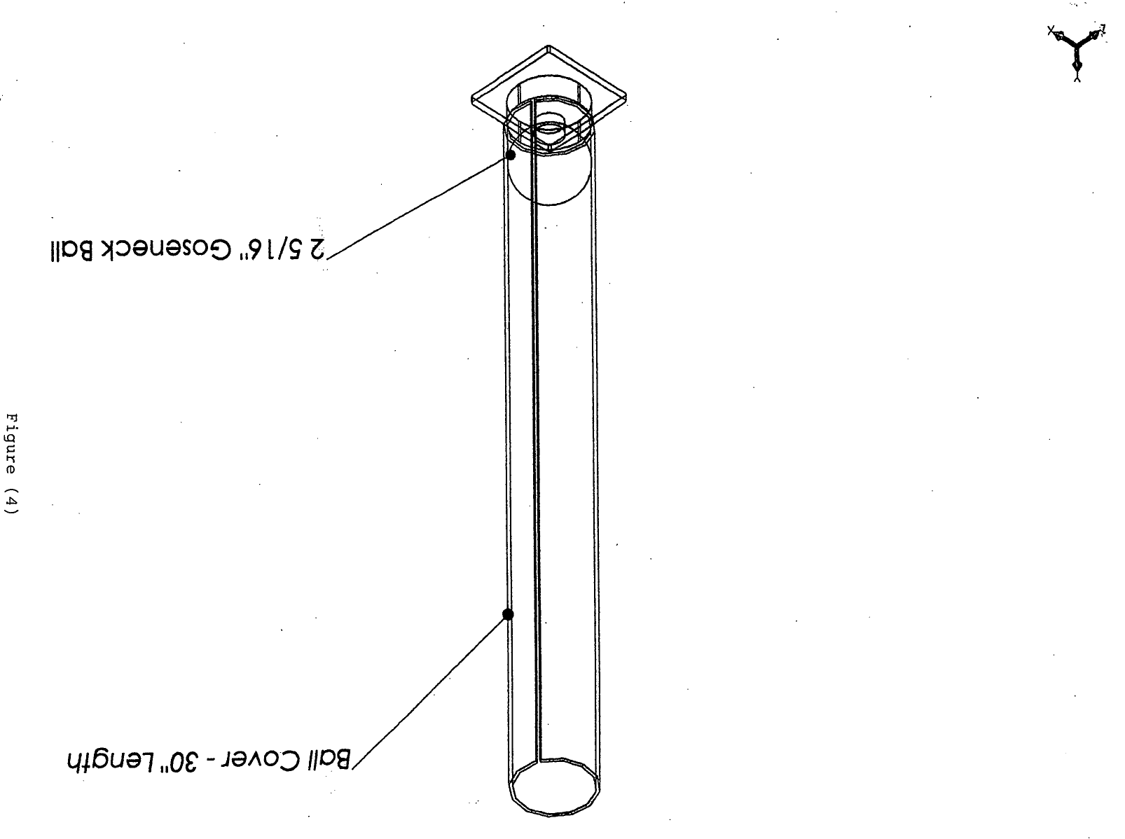

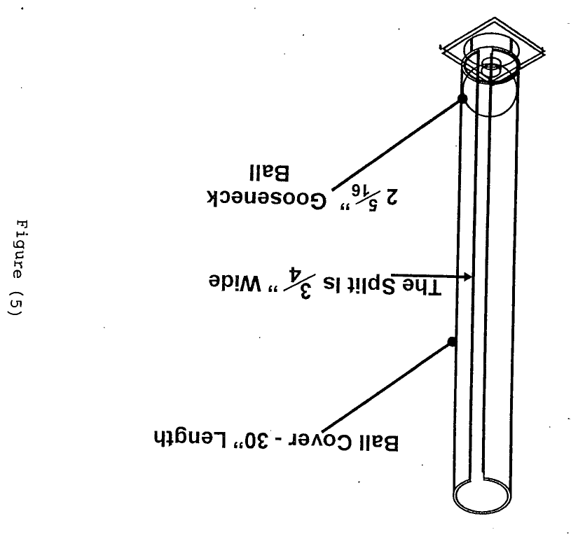

FIGS. 4 and 5 illustrate the relationship of the “Gooseneck Hook-up Helper with the ball and FIG. 5 shows the ¾ inch split, which extends the full length. This split is necessary to allow the “Gooseneck Hook-up Helper” to be easily disengaged from the ball when struck by the trailer hitch.

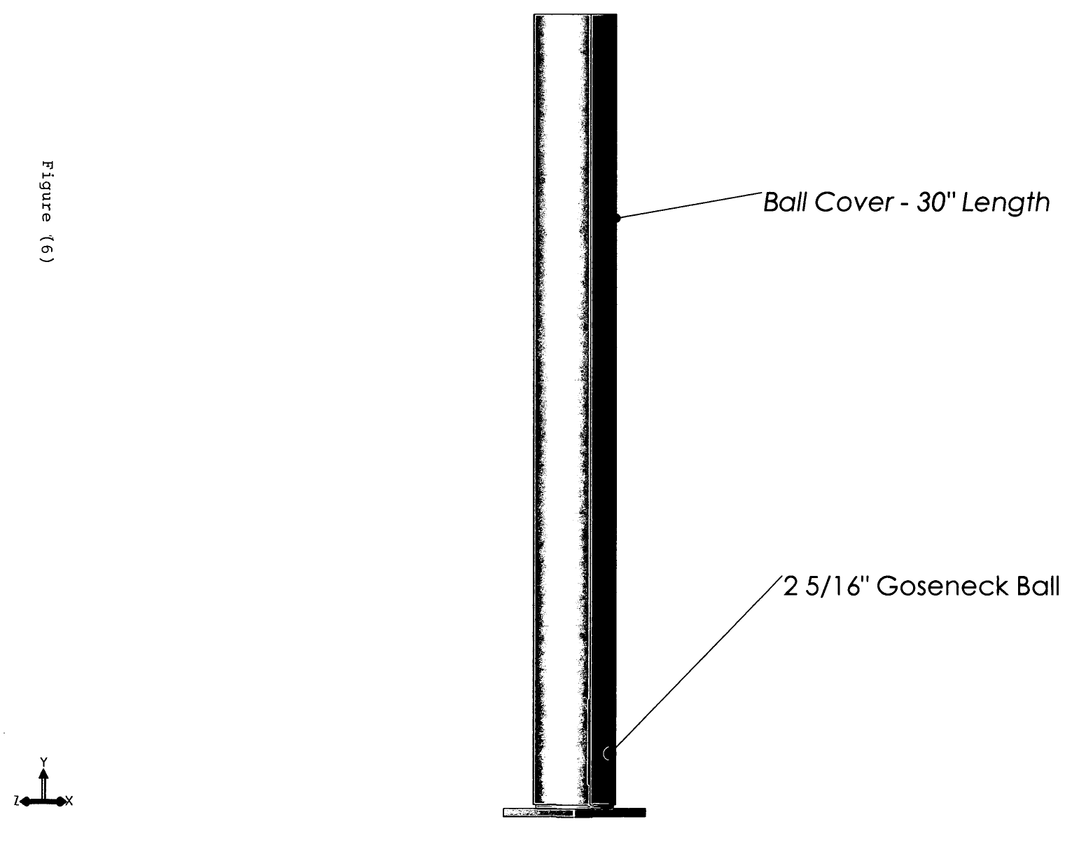

FIG. 6 is an example of the luminescent color that is manufactured as an integral pigment to the chemical mixture that makes up “Gooseneck Hook-up Helper”. The physical shape and color make it easy to see, not only during the day, but at night when the luminescence of this added color reflects light and appears to glow in the dark.

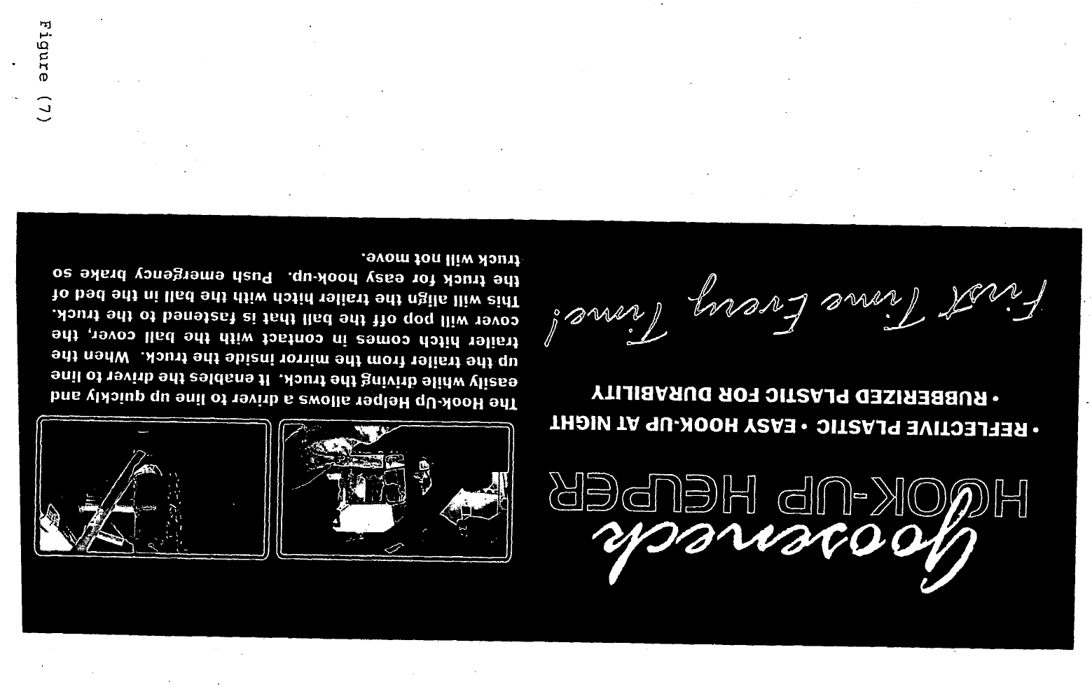

FIG. 7 is a copy of the actual instructions that are attached to each helper.

### OPERATION

To use the “Gooseneck Hook-Up Helper” the operator will climb into the bed of the truck, make sure the towing ball is in the right position for hitch attachment, place the “Gooseneck Hook-Up Helper” in an upright position over the ball, with the ¾ inch split facing the rear of the truck, and press down until it is seated. The operator then enters the truck and begins backing up to the trailer hitch. At this point the driver may look behind to align the truck to the hitch, but the preferred method is to use the vehicle's rear view mirror to align. When the trailer hitch comes in contact with the “Gooseneck Hook-Up Helper” it will pop off the ball. This will correctly align the trailer hitch with the ball, in or on the bed of the truck, for easy hook-up. At this point the driver should engage the emergency brake to preclude movement of the truck, fore or aft, when removing the foot from the brake pedal or putting the transmission into Park.

### CONCLUSION, RAMIFICATIONS, AND SCOPE

Accordingly, the reader will see that the “Gooseneck Hook-Up Helper” will greatly assist the driver in the proper alignment and hook-up of a gooseneck trailer without having to frequently stop, get out of the vehicle to verify the alignment of the ball to the hitch, or the need for an additional person to voice or signal directions to the driver. The “Gooseneck Hook-up Helper” provides superior visibility in all weather conditions and levels of light from the safety and security of the vehicle. Its sturdy yet flexible construction makes it impervious to all weather conditions as well as chemicals and or other substances that it might come in contact with.

1. A method for joining two mobile wheeled conveyances to a point of connection comprising the following steps:
a. move both conveyances, one powered the other stationary, toward a predetermined point using a mirror and a tubular post for alignment.
b. when the two conveyances converge the post will indicate proper alignment.
